(19) United States
(12) Patent Application Publication
(10) Pub. No.: US 2026/0111945 A1
(43) Pub. Date: Apr. 23, 2026

(54) Content Management Arrangement

(71) Applicant: Nina Data Oy, Helsinki (FI)

(72) Inventors: Seshadri Sastry Kunapuli, Visakhapatnam (IN); Praveen Chakravarthy Bhallamudi, Srikakulam (IN)

(73) Assignee: Nina Data Oy, Helsinki (FI)

(21) Appl. No.: 19/117,657

(22) PCT Filed: Oct. 2, 2023
(86) PCT No.: PCT/FI2023/050560

§ 371 Date: Apr. 2, 2025

(30) Foreign Application Priority Data
Oct. 4, 2022 (FI) 20225892

(51) Int. Cl. G06Q 30/0601

(52) U.S. Cl. CPC G06Q 30/06311

(57) ABSTRACT

An arrangement for managing embedded content it is provided. The arrangement is able to provide relevant embedded content to different websites and applications without having direct input in form of cookies. The content management arrangement uses contextual targeting using a large dataset comprising contextually classified data. The classified data is then used in contextual targeting based on the context of the content requesting embedded content.

### DESCRIPTION OF BACKGROUND

The present disclosure relates to recommendation systems in the world wide web or application-based computing. Particularly the present disclosure relates to mechanisms for providing useful and required embedded content to the users.

Currently recommendation systems are typically used for advertising either commercially available products or other information. These recommendations are commonly based on the browsing history of a user. The browsing history is commonly tracked using cookies that are small files and store information about the behavior of the tracked user. This information may be used for behaviorally based targeting. Behaviorally based targeting may be supplemented by using contextual targeting that is based on the content of the showing site.

A problem with the conventional approach using cookies is that many users do not allow using cookies. Furthermore, cookies often involve problems with information security and are possible source of hacking and unauthorized entries to a computing device. Furthermore, cookies and the information collected using cookies is causing conflicts with privacy regulations around the world and are a potential source of data security problems as confidential data of user may leak in case of hackers. Particularly third-party cookies, which are cookies that have been set by a website other than the current one being used are suspicious in view of privacy and data security reasons. Thus, there is a need for moving away from cookies and similar technologies.

### SUMMARY

A content management arrangement is disclosed. An arrangement particularly for managing embedded content it is provided. The arrangement is able to provide relevant embedded content to different websites and applications without having direct input in form of cookies. The content management arrangement uses contextual targeting using a large dataset comprising contextually classified data. The classified data is then used in contextual targeting based on the context of the content requesting embedded content.

In an aspect of the content management arrangement a method for managing content is disclosed. The method comprises receiving a request for at least one embedded content item; determining at least one relevant embedded content item in accordance with the request; and transmitting the determined at least one relevant embedded content item as a response to the request, wherein determining the at least one relevant embedded content item using a dataset arranged into a plurality of classes according to the context of the dataset items. A benefit of the aspect is that it is capable of determining relevant content without storing any additional information with regard the user using a service, where the embedded content is shown. This facilitate targeting also in cases where the user has forbidden storing such information, for example, in form of cookies.

In an implementation of the aspect the dataset arranged into a plurality of classes is derived by collecting main content by crawling a plurality of websites. It is beneficial to crawl a large amount of content to have good coverage of available relevant content.

In an implementation of the aspect the main content is tokenized. It is beneficial to tokenize the content so that it will be easier to process. When the sentences are tokenized into words, the tokenized words can be analyzed.

In an implementation of the aspect the tokenized main content is arranged into a matrix, wherein each unique word in the main content is represented by a column and each text sample of the main content is a row in the matrix. It is beneficial to organize the tokenized words in a structured manner so that the required analysis can be done.

In an implementation of the aspect the method further comprises arranging dataset into the plurality of classes further comprises extracting keywords from the main content. It is beneficial to use keywords as they can be interpreted as representing a distribution over sub-contexts and vice versa. This enables explainability in an efficient and natural manner.

In an implementation of the aspect the method further comprises using a pre-trained bidirectional encoder from transformers (BERT) embeddings in said extracting keywords. This enables the said ability to both have explainability via keywords and at the same time encode sub-context as a distribution over a vast number of sub-contexts.

In an implementation of the aspect the method further comprises generating long keywords from the extracted keywords and the main content, wherein a long keyword comprises a plurality of words in a sequence. The benefit of this is that the sequences capture the meaning more precisely, i.e. have a more specific distribution over possible contexts than simple words.

In an implementation of the aspect the method further comprises labelling according to the presence of words in a sentence of the main content. This enables the construction of a model based on modelling context as combinations of occurrences of words around a specific point of attention in the text.

In an implementation of the aspect the method further comprises obtaining an attention mask based on the labelled words. This enables the model to capture the most influential surrounding words of each word, instead of storing confusing or superfluous sub-contexts.

In an implementation of the aspect the collected main content is cleaned, wherein the cleaning comprises removing at least one of the following: malformed words, words in another language and words comprising special characters. The benefit of this is to meet the assumptions of the model optimally.

In an implementation of the aspect the transmitting the determined at least one relevant embedded content item comprises transmitting at least one URL or a pointer associated with the relevant embedded content items.

In an aspect of the content management arrangement a method for managing content is disclosed. a computer program is disclosed. The computer program comprises computer program code, which when executed by a computing device, is configured to perform a method described above.

In an aspect an apparatus is disclosed. The apparatus comprises at least one processor; and at least one memory including computer program code, the at least one memory and the computer program code being configured, with the at least one processor, to cause the apparatus to perform a method described above.

The aspects and implementations discussed in the above provide a possibility to target embedded content so that content providers are able to reach their target audience without using cookies. This improves data security, privacy and even improves targeting matching as contexts are taken more holistically into account when deciding the content. Furthermore, the approach provides also a solution to those situations wherein users have specifically forbidden the use of cookies. Thus, this arrangement provides more flexibility for content providers to provide content so that more interesting sites and application views can be generated.

### BRIEF DESCRIPTION OF THE DRAWINGS

The accompanying drawings, which are included to provide a further understanding of the content management arrangement and constitute a part of this specification, illustrate embodiments and together with the description help to explain the principles of the content management arrangement. In the drawings:

FIG. 1 is a block diagram of an example arrangement comprising a content management arrangement,

FIG. 2 is an example of a method for content management arrangement,

FIG. 3 is an example of a method for content management arrangement, and

FIG. 4 is an example of a method for content management arrangement.

### DETAILED DESCRIPTION

Reference will now be made in detail to the embodiments, examples of which are illustrated in the accompanying drawings.

In the following disclosure site, website or an application will be discussed. The content management arrangement is able to work all kinds of sites, websites and applications provided that the contextual information is retrievable and processable according to the principles discussed in the following.

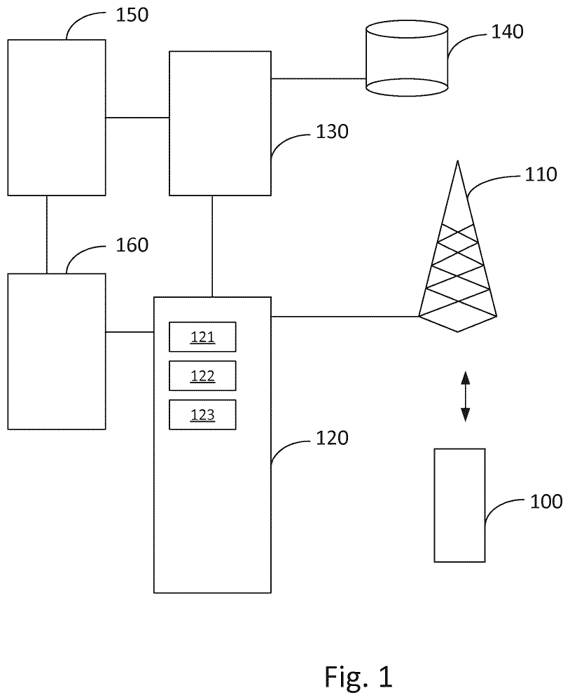

In FIG. 1 a block diagram of a content management arrangement comprising an embedded content selection system 130, embedded content provider system 150 and embedded content management system 160 according to the present disclosure. The block diagram of FIG. 1 is an example and actual implementations may comprise additional elements or used different elements having functional similar to the functionality described together with the example.

The arrangement comprises end user devices, such as the end user device 100 of FIG. 1. The end user device is typically a mobile phone, tablet or pad type of computer, laptop computer or similar. The user of the device typically uses services using a browser software or dedicated applications. In the following example it is assumed that the used services are able of showing embedded content to the user. An example of embedded content is an advertisement of a product or another service, however, it may be any kind of embedded content which can be selected using context aware methods.

The user terminal is connected to the Internet using, for example, a mobile communication network 110. The mobile communication network, or other wireless communication network, uses a base station that couples the user terminal with one or more services 120 on the Internet. These services are further connected to an apparatus for embedded content selection system 130. The apparatus may have an additional access to a data storage 140. Typically the number of managed data items is very large and thus, a separate data storage may be needed. The embedded content selection system 130 is further connected to embedded content provider system 150 and embedded content management system 160. Embedded content providers, which may be, for example, an advertiser, is connected to the embedded content selection system 150 and the embedded content management system 160.

In the example the apparatus and data storage have been introduced as separate components, however, they may also be arranged as a single entity. The single entity may be a server, however, it can also be a cloud service or other virtual server that is constructed using a plurality of components and shared among other services.

The arrangement of FIG. 1 is an example and any other suitable arrangements that are capable of performing the functionality described below is suitable. The user of the user terminal 100 uses different services with a browser or similar program. These services may be webstores, news services, games or any other service that can be equipped with embedded content for promoting additional content. When users use these services they are constantly sending indications by clicking different types of content, making purchases or other behavioral impressions that are received at the services 120. These services are connected to the embedded content selection system 130 so that the content selection system can recommend embedded content to be shown with the services 120 so that the embedded content matches contextually with the used service 120. This is achieved so that embedded content provider systems 150 request from the embedded content selection system 130 recommendations where the content provided by the respective embedded content provider should be shown. The embedded content selection system 130 provides at least one recommendation to the embedded content provider 150, for example, as a list of URL's or other pointers. The embedded content provider system then provides the content to embedded content management system 160 so that the services 120 can generate desired views.

The principles of the recommendation arrangement will be explained in detail together other examples in below. The embedded content selection system 130 is configured to crawl through a very high number of websites. The websites are classified according to their context. As the number of classified websites is very high it is possible to use an additional data storage 140 for storing these classifications. Now, when an entity is wishing to promote their embedded content with one of the services 120, the entity will provide the content to the embedded content selection system 130. The embedded content selection system 130 analyzes the received content. The analyzed content may then be compared with the content received from an embedded content provider to which recommendations of one or more services can be provided as a response. The response comprises services that are contextually optimized to be suitable for content of the embedded content provider systems. Services 120 include at least one embedded field for providing embedded content. This field is then filled with the content that has been transmitted from the embedded content management system 160 to at least one service 120.

Embedded content providers receive one or more recommendations for the content from the embedded content selection system 130. Thus, one service may receive different recommended contents when accessing the embedded content management system 160 for generating a view. For example, in case of advertisements the recommended content may be two or three different advertisements that are shown to the end user in accordance with content showing parameters. Thus, the embedded content management system may provide different content each time the services generate a view.

The in the example of FIG. 1 the components and systems are shown as parts of a content management system. These components may be maintained by different legal entities, and they may be physically different. However, it is possible that one or more of these components 120-160 are integrated in an entity that is responsible for the whole service.

Figure two discloses an example of a method in a content management arrangement. In the example the arrangement is presented in a form of a method, however, a person skilled in the art understands that the example is not limited to a sequential method but is more like a process as it is processing content that evolves over the time.

The method is initiated by collecting content by crawling internet sites and preprocessing the collected content, step 200. Crawling different websites provides a possibility to collect content that can be classified and used in content management.

After preprocessing the content, a set of textual sub-contexts are recognized in the content, step 210. Recognized sets are sets that work best in classification of the content in the main variable of interest, the so-called taxonomy, typically interactive advertising bureau taxonomy as used in standard fashion in programmatic advertising. These sub-contexts are represented by contextual keywords that capture the content best for the purpose of classification.

Then prediction against a range of variables and representations is performed, step 220. The purpose of this is to determine the intent of the user. The intent relates to what the user is wishing to see. Thus, the intent corresponds with the relevancy of the intended content to the user. In case of a shop or additional service it might be what the user is interested in, what her willingness to purchase is, is the context positive or negative and what conceptual keywords would best capture the content.

When a content provider wishes to do contextual targeting, she specifies her needs and the content management arrangement fetches the closest already analysed inventory in the contextual semantic space generated by content management arrangement. This is relevance matching, step 230, may generate one or more items for providing embedded content.

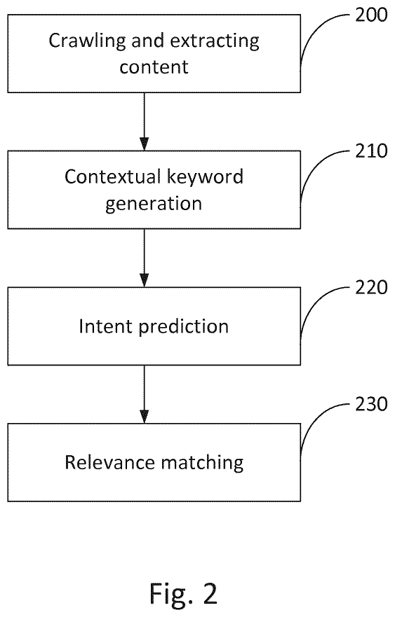

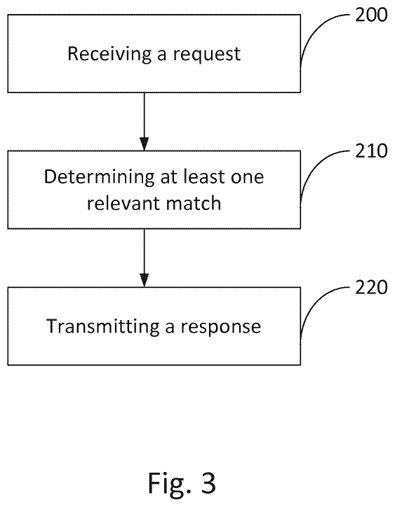

FIG. 3 discloses more practical example for a content management arrangement, wherein the similar principles. In the method the content management arrangement receives a request from a content provider, step 300. The request comprises targeting needs as discussed above with regard step 230 of the example of FIG. 2. These targeting needs are then matched against earlier analyzed content for determining at least one relevant match, step 310. The relevance matching may provide a plurality of matches, from which optionally a smaller subset of relevant matches is selected. The plurality or the subset is then returned to the content provider as a response, step 320. The received plurality or subset may be, for example, a set of addresses, websites, URL's or similar that identifies a service to which the content should be targeted. As the information is received from the content management system, there is no need for direct communication between the content provider and the user when determining the relevant additional content that will be embedded to the service. Thus, use of cookies can be avoided.

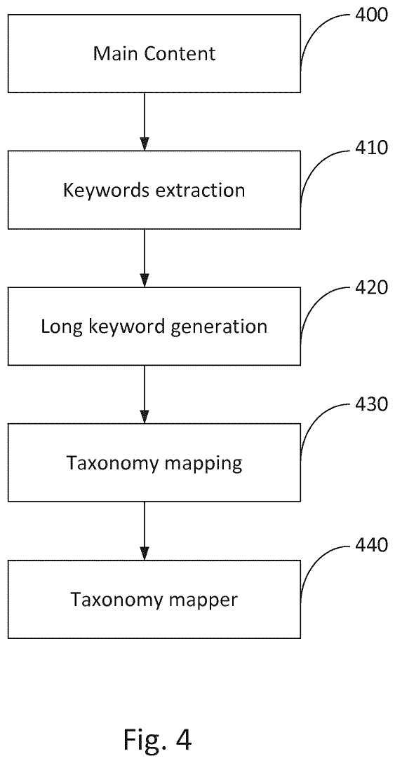

FIG. 4 discloses an example of a method for content management arrangement. The method is initiated by acquiring the content, step 400. This may be done by crawling different sites as explained above. The acquired content is first pre-processed. Pre-processing extracts words from the text of the content. The acquired text is first tokenized. Tokens are words separated by spaces and punctuation. Thus, tokenization means dividing the sentences into words. The punctuation marks are removed and all the words are converted to lowercase which allows it to learn vocabulary dictionary of all tokens in the raw documents. This creates a dictionary of tokens that maps every single token to a position in an output matrix. After tokenization, the created tokens are vectorized which creates a matrix in which each unique word is represented by a column of the matrix, and each text sample from the document is a row in the matrix. The value of each cell is the count of the word in that particular text sample.

From the tokenized content keywords are extracted, step 410. A keyword extractor uses pre-trained Bidirectional Encoder Representations from Transformers (BERT) embeddings to extract keywords for a list of words produced after the pre-processing step. The BERT architecture is an example that can be used in the content management arrangement. Bert is a transformer-based machine learning technique that is suitable for natural language processing pre-training. Also other suitable methods may be used.

The tokens created in pre-processing step 400 are processed further to make them ready for BERT processing. To process the tokens, the first step is content trimming. BERT requires inputs to be in a fixed size and shape. As it is possible that some content items exceed the size, it may be necessary to trim the content to the required size and to keep it in the required shape. The next step was to add special tokens [CLS] and [SEP] to the input. BERT uses special tokens [CLS] and [SEP] to understand input properly. A [SEP] token has to be inserted at the end of a single input and a [CLS] is a special classification token.

In order to extract most context-related keywords, BERT embeddings of the whole document and extracted keywords in pre-processing step are searched and found. After finding embeddings, cosine similarity is calculated between individual keyword embeddings and document embeddings. The cosine distance would range from −1 to 1, 1 being most similar and −1 exactly opposite and 0 indicating orthogonality. Keywords which are having more similarity scores are selected. These keywords represent the nearest keywords of the context of the content.

After keyword extraction long keywords are generated, step 420. Long keywords are generated from keywords and the main content. Main content is text extracted from a website. Long keywords are keywords consisting of more than one word in a sequence. The long keywords may be generated using one or more keyword extraction datasets. For example, datasets such as NLM_500, SemEVAL2010-Maui, theses100 and wiki20 or similar, in order to get a huge dataset. After collecting the dataset, the contexts are merged into a single file as a single large corpus and all the keywords into another file. Then the data is cleaned before processing it in-order to remove any malformed words or the words in any other language or any other special characters in the corpus.

After cleaning the dataset, tokenize are tokenized from the corpus and again the sentences are tokenized into words using word tokenizer. Those words are then converted into individual token ids for training the network.

The words are then labelled. Labels are defined as a list of ‘1’s and ‘0’s. If the word is present in a sentence then it is marked as ‘1’. Else the word is marked as ‘0’. The purpose is to convert the labels into a list of ‘1’s and ‘0’s based on the words contained in the sentence. As these are used to train a deep learning model, also the attention masks are obtained. Attention masks can be obtained by replacing all the words as ‘1’s in the sentence list and extending the list to the maximum length of the sentence (i.e., 768) in the corpus, by padding zeros until the end of the list.

Then input token ids and attention masks are fed as input to the pre-trained “Bi-directional Encoder Representation Transformers (BERT)” to convert those token ids into a vector of unique embeddings for every sentence, based upon the attention masks and the words comprising the sentence.

These embeddings can be extracted from the last layer of the pooling in a pre-trained model. It is possible to add extra layers to the end of the model based upon the requirement of the output of the maximum sequence length. As the number of keywords to extract from a sentence is not pre-defined and that could be maximum of one to many, it is recommended to utilize a Softmax activation function at the end with categorical cross-entropy as the loss function with Mean Absolute Error (MAE) and Accuracy as the metric.

After the model is trained, it is stored. The model is used to get the embeddings whenever a sentence or a corpus was given as the input. Then the keyword embeddings are compared with the complete corpus embeddings to get the top ranked keywords in the model based upon the distances. It is possible to use the maximum sum similarity (MSS) metric in order to find the cosine distances between each and every keyword to the corpus. Before finding the distances, the count-vectorizer may be used in order to remove the repeated words based upon the frequencies and also remove the stop words that don't provide much relevance to the text.

Instead of single keywords, if long keywords are required up to some length, then it is possible to use n-grams. In general, the process typically utilizes a 3*3 n-grams so as to provide a long keyword of length 3 words for the recommendation system.

Then taxonomy mapping is performed. A taxonomy mapper finds the context-related segmentation of main content using keywords and long keywords. The taxonomy mapper takes the list of long keywords as one input and Interactive Advertising Bureau (IAB) taxonomy classes along with their sub-classes as another input. This Interactive Advertising Bureau (IAB) taxonomy consists of 33 segments and subsegments for some. To make this data, we collect a high number, for example, one million URLs, which cover all the IAB segmentations. From these URLs, keywords and long keywords have been extracted for all segmentations. Using the BERT model these long keywords are converted into embeddings. This provides embeddings for all IAB classes and subclasses.

The long keywords received from the “Long Keyword Extractor” component are converted to embeddings using the BERT model. In order to find the contextual segmentation of long keywords derived from “Long Keyword Extractor”, it is possible to calculate the cosine similarity of long keywords with embeddings of IAB segmentation and the segment with the best similarity would be the most contextually related segmentation for the main content.

The arrangement and methods discussed above may be used in several different use cases for generating views in websites or applications. In the following only some examples are given.

In the first example contextual publisher intent analysis use case is discussed. In the following the use case is introduced so that a necessary training can be performed.

Understanding the in-moment mindset of the desired audience is crucial. The intent-based method is involved with using a version of an advertisement based on the prospect's stage of preparedness to buy, in the pre-contextual past typically evidenced by their actions and behavior. To gauge their stage, cookies have been typically used. In the use case the approach focuses on classifying the publisher's intent based on the content of the page. The most immediate application of the method is in matching the type of the campaign (e.g. brand awareness oriented one vs. a purchase oriented one).

The procedure of the first use case is to find the publisher's intent and match it to the advertiser's intent. For example, if an advertiser wants to sell cars, the method recommends web pages where the publisher's intent is transactional. There are three types of Publisher Intent: 1) Informative, 2) Navigational and 3) transactional. When the crawler crawls websites from the net, the algorithm finds the intent of every page and tags it with that intent. In order to train the network approximately 30,000 web pages were crawled and intents were manually tagged to them. Then the BERT model was fine-tuned by adding corresponding top layers to it. Of the collected data about 70% was used for training and cross-validation and 30% of the collected data for testing. Finally three more classes were added and trained the deep learning model for six classes including: 1) informational, 2) transactional, 3) navigational, 4) navigational transactional, 5) transactional download and 6) navigational informational.

Examples of the training set are disclosed in the following: “online broker reviews”—Informational; “unclaimed property consultants”—Transactional, Informational; “Get a loan in minutes”—Navigational Informational; “Consult Doctor Online”—Navigational transactional, Navigational Informational; “buy e-books online”—Transactional Download; “Games online”—Transactional Download;

In the second example, the contextual sentiment analysis use case is discussed. In the following the use case is introduced so that a necessary training can be performed. Sentiment analysis deals with identifying and classifying opinions or sentiments expressed in the source text. Nowadays a vast amount of data is posted in a form of blogs, articles, and landing pages online regularly. The sentiment analysis of this posted data is very useful in knowing the opinion/sentiment of the author. By definition, a lexicon means “stock of terms used in the article”. Analyzing the lexicon can, for example, be done by identifying the frequency of usage of some particular words. These words can be labeled with the help of human intervention and then a model be trained to calculate and predict the sentiment of the data based on the labels. Many researchers have proposed different techniques in the literature that perform well for a particular type of data input or type of article. In the following a more general approach is described within the realm of contextual intelligence by training a deep learning model using a zero-shot learning classifier. The zero-shot learning classifier recognizes the sentiment of a webpage by contextual means, irrespective of the type of data given, or the length of the words given as input to it, and achieved a real-time accuracy of more than 90%. The particular importance of sentiment analysis to the field of contextual programmatic advertising lies in the desire of advertisers to maintain brand safety. There are contexts where it is not “safe” for ads to appear. In more particular terms, this might involve using a specific taxonomy for the purpose such as Terrorism, Adult content etc. A non-taxonomic aspect is the sentiment of the page. Negative contexts are often not seen as amenable for advertising. Therefore, a precise method of detecting such contexts is critical.

To train the model data from blogs, landing pages and similar sources is collected. The collected data comprises individual positive, negative, and neutral data samples. The BERT based architecture is again used. Other architectures that have predefined or fixed embeddings for every keyword and the same keyword might give different meanings for different contexts, hence changing the complete meaning of the sentence. For example, the keyword ‘bank’ could relate to “financial bank” or a “river bank”. If a fixed embedding is used for the keyword then it might change the meaning of the complete sentence while training, or it could be meaningless sentence.

In the example a “best-base uncased model” is used as a tokenizer to tokenize every sentence with [CLS] and [SEP] tokens. Furthermore the pooling layer of the pre-trained model is extracted to get the output from the last attention head layer for embeddings which is used as input to a multi-layer perception model. The functional flow of the process contains the basic preparation of the dataset as a first step. The dataset is typically a mixture of several custom and pre-existing datasets such as Twitter and movie sentiment datasets. While doing pre-processing, the usage of regular expressions to limit the dataset from special characters and duplicate sentences has been determined. Then this text is processed in the model with a BERT-based pre-trained batch encoder during training. In the testing process, the text is scraped from a webpage using a content extractor, and we repeat the pre-processing and batch-encoding state during prediction.

In the third example, the contextual targeting keywords use case is discussed. In the following the use case is introduced so that a necessary training can be performed. Keyword targeting allows advertisers to choose keywords related to their products to get customer views, downloads or similar. This strategy works better when the advertiser knows the search terms that customers use to search for products similar to them. For example, if your product is a microcar, you may choose the keyword “microcar.” When a shopper searches for a product with the search term “microcar,”, an advertisement relating to advertiser's microcars would be visible for them as URLs resulting from the search. The main aim of this research is to find a potential targeting keyword in a URL that could be used to target that page and recommend the page to advertisers. Target keywords can be described as simple keywords that mimic the way humans have traditionally used keywords to target. Yet the ones of the example are contextually produced and not necessarily occurring literally in the text or in a prominent role in terms of frequencies. They should therefore be seen as purely semantic concepts rather than in the traditional keyword-based matching. Their semantics are also very much driven by traditional usage of keywords, thereby providing an easy mechanism to adapt to from an older generation of targeting mechanisms, wherein, for example, cookies may be needed.

In the example a T5 Transformer is fine-tuned to learn how to generate Targeting Keywords. In the example 10,000 data samples are used to train the model. The T5 model is based on the transformer model architecture, which uses stacks of self-attention layers instead of recurrent neural networks or convolutional neural networks, to handle a variable-sized input. When an input sequence is provided, it is translated into a set of embeddings and passed to the encoder. Each encoder has the same structure and is made up of two subcomponents: a self-attention layer and a feed-forward network. A normalization layer is applied to each subcomponent's input, while a residual skip connection connects each subcomponent's input to its output. A dropout layer is applied to the feed-forward network, the skip connection, the attention weights, and the complete stack's input and output.

The decoders work in the same way that the encoders do: each self-attention layer is followed by an extra attention mechanism that pays attention to the encoder's output. The last decoder block's output is sent into a Linear layer, which has a Softmax function as an output layer. The T5 model, unlike the general transformer model, uses a simplified form of position embeddings, in which each embedding is a scalar that is added to the relevant logit used to compute the attention weights. The T5 transformer model has two main advantages over other state-of-the-art models. Firstly, it is more efficient than RNNs because it allows the output layers to be computed in parallel, and secondly, it can detect hidden and long-ranged dependencies among tokens without assuming that tokens closer to each other are more related.

Targeting keywords are trained to produce 1-5 Keywords. The first keyword would be of higher importance, the second keyword would have the second-highest importance in targeting, and so on. IT is possible to prepare another model to predict scores similar to probability scores for keywords using the Linear regression model.

The above mentioned methods may be implemented as computer software which is executed in a computing device able to communicate with a mobile device. When the software is executed in a computing device it is configured to perform the above described inventive method. The software is embodied on a computer readable medium so that it can be provided to the computing device, such as the content management arrangement of FIG. 1.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the content management arrangement may be implemented in various ways. The content management arrangement and its embodiments are thus not limited to the examples described above; instead they may vary within the scope of the claims.

1. A method for managing content comprising:
receiving a request for at least one embedded content item;
determining at least one relevant embedded content item in accordance with the request; and
transmitting the determined at least one relevant embedded content item as a response to the request,
wherein determining the at least one relevant embedded content item using a dataset arranged into a plurality of classes according to the context of the dataset items.

2. A method according to claim 1, wherein the dataset arranged into a plurality of classes is derived by collecting main content by crawling a plurality of websites.

3. A method according to claim 2, wherein the main content is tokenized.

4. A method according to claim 3, wherein the tokenized main content is arranged into a matrix, wherein each unique word in the main content is represented by a column and each text sample of the main content is a row in the matrix.

5. A method according to claim 1, wherein arranging dataset into the plurality of classes further comprises extracting keywords from the main content.

6. A method according to claim 5, wherein the method further comprises using a pre-trained bidirectional encoder from transformers (BERT) embeddings in said extracting keywords.

7. A method according to claim 5, wherein the method further comprises generating long keywords from the extracted keywords and the main content, wherein a long keyword comprises a plurality of words in a sequence.

8. A method according to claim 7, wherein the method further comprises labelling according to the presence of words in a sentence of the main content.

9. A method according to claim 8, wherein the method further comprises obtaining an attention mask based on the labelled words.

10. A method according to claim 2, wherein the collected main content is cleaned, wherein the cleaning comprises removing at least one of the following: malformed words, words in another language and words comprising special characters.

11. A method according to claim 1, wherein the transmitting the determined at least one relevant embedded content item comprises transmitting at least one URL or a pointer associated with the relevant embedded content items.

12. A computer program embodied on a computer readable medium comprising computer program code, which when executed by a computing device, is configured to perform a method according to claim 1.

13. An apparatus comprising:
at least one processor; and
at least one memory including computer program code, the at least one memory and the computer program code being configured, with the at least one processor, to cause the apparatus to perform a method according claim 1.
